(19) United States
(12) Patent Application Publication
(10) Pub. No.: US 2002/0130599 A1
(43) Pub. Date: Sep. 19, 2002

(54) Cathode ray tube having plurality of electron guns

(75) Inventors: Tae-Sik Oh, Suwon-city (KR); Eui-Jeong Hwang, Yongin-city (KR)

Correspondence Address: STAAS & HALSEY LLP, 700 11TH STREET, NW, SUITE 500, WASHINGTON, DC, 20001, US

(73) Assignee: Samsung SDI Co., Ltd., Suwon-city (KR)

(21) Appl. No.: 10/078,416

(22) Filed: Feb. 21, 2002

(30) Foreign Application Priority Data
Mar. 14, 2001 (KR) 2001-13234

(51) Int. Cl. H01J 31/00

(52) U.S. Cl. 313/2.1

(57) ABSTRACT

A cathode ray tube of the present invention includes a face panel having a phosphor screen formed on an inner surface of the face panel, a funnel fused to the face panel on one end and having a plurality of cones on the other end, and a plurality of necks connected to a corresponding one of the cones. Each of the necks is provided with an electron gun which emits electron beams toward the phosphor screen. A plurality of deflection yokes which deflect the electron beams are mounted to an outer circumference of each of the cones. In addition, a plurality of stems are fused to a corresponding distal end of the necks and connected to the electron gun provided in the corresponding neck. The stems include a first stem having a sealing cap extending outward from the neck to which the first stem is fused, and second stems formed such that each of the second stems is without the sealing cap.

### CROSS-REFERENCE TO RELATED APPLICATIONS

This application claims the benefit of Korean Application No. 2001-13234, filed Mar. 14, 2001, in the Korean Patent Office, the disclosure of which is incorporated herein by reference.

### BACKGROUND OF THE INVENTION

1. Field of the Invention

The present invention relates to a cathode ray tube, and more particularly, to a cathode ray tube which realizes an image with the use of a plurality of electron guns.

2. Description of the Related Art

A cathode ray tube (CRT) is a display device having an electron gun which emits three R,G,B electron beams corresponding to image signals. These beams are directed toward a phosphor screen and excite phosphors to realize desired images. Specifically, the emitted electron beams are deflected by a deflection yoke, which generates a magnetic field, and pass through a shadow mask, which performs a color selection function of the electron beams onto corresponding R,G,B phosphors of the phosphor screen.

To ensure that the electron beams are sufficiently displaced by a deflection operation of the deflection yoke, it is necessary to place the electron gun at a predetermined distance from the phosphor screen (i.e., that the CRT has at least a predetermined length or depth). This restriction places a limit on how little or flat a CRT can be manufactured.

To effectively minimize the length of the CRT while having a screen that is flatter and larger in size, U.S. Pat. Nos. 5,498,921 and 5,584,738 disclose a multi-neck CRT in which a plurality of electron guns and deflection yokes are provided in the multi-neck CRT. A screen of the multi-neck CRT is divided into multiple regions, and each region is provided with an electron gun and a deflection yoke. With this configuration, electron beams emitted from the electron guns are deflected separately to scan their corresponding screen region. Accordingly, the length of the CRT may be reduced while providing for a larger screen size.

However, with the above multi-neck CRT structure, it is not possible to apply typical single exhaust and exhaust tube sealing processes. That is, with the multi-neck structure, each electron gun is fixed to a corresponding one of stems and each of the stems, which are fused to a corresponding one of necks, include a hole which is connected to a corresponding one of exhaust pipes. Therefore, the air in a conventional multi-neck CRT is evacuated through the multiple exhaust pipes requiring multiple exhaust and exhaust tube sealing processes.

FIG. 11 shows a conventional multi-neck CRT structure attached to an evacuation unit 5. During the manufacture of the multi-neck CRT, the air in the multi-neck CRT is evacuated using the exhaust unit 5 which includes a number of suction pipes 3 corresponding to each of the stems 1. After the evacuation, exhaust pipes of the multi-neck CRT are sealed. However, the sealing of the exhaust pipes involves a complicated process. Therefore, the unit manufacturing cost of the conventional multi-neck CRTs is high, making a mass production of the multi-neck CRT difficult. In addition, since multiple exhaust and sealing processes are required, gases generated during the processes are more likely to enter the multi-neck CRT. Accordingly, the degree of vacuum is reduced, thereby reducing the quality of the multi-neck CRT.

If a conventional exhaust unit is used to evacuate the multi-neck CRT (as opposed to using a special unit designed for the multi-neck CRT), it is necessary to first perform the additional steps of sealing all but one of the stems designated as an evacuation stem. In addition, with the use of heat to seal the exhaust pipes in an atmospheric pressure environment, electron guns are oxidized by the flames such that the performance of the electron guns is reduced.

Japanese Patent No. Hesei 2000-48725 discloses a multi-neck CRT structure with an exhaust pipe provided to a side portion of the multi-neck CRT. In this case, the air is evacuated through the side exhaust pipe. However, this arrangement results in a complicated structure requiring an additional processing step to attach the side exhaust pipe.

### SUMMARY OF THE INVENTION

Accordingly, it is an object of the present invention to provide a cathode ray tube (CRT) having a plurality of electron guns, in which an exhaust process and an exhaust tube sealing process may be performed identically as in a conventional CRT having a single neck, without requiring additional processes or special devices.

Additional objects and advantages of the invention will be set forth in part in the description which follows and, in part, will be obvious from the description, or may be learned by practice of the invention.

To achieve the above and other objects of the present invention, there is provided a cathode ray tube (CRT) comprising a face panel including a phosphor screen formed on an inner surface of the face panel, a funnel including one end fused to the face panel and another end having a plurality of cones, a plurality of necks connected to a corresponding one of the cones, a plurality of electron guns which emit electron beams toward the phosphor screen provided to a corresponding one of the necks, a plurality of deflection yokes which deflect the electron beams emitted from the electron guns mounted to a corresponding outer circumference of the cones, and a plurality of stems fused to a corresponding distal end of the necks and connected to a corresponding electron gun provided in the necks, wherein the stems include a first stem having a sealing cap which extends outward from the neck to which the first stem is fused, and second stems formed such that each of the second stems is without the sealing cap.

According to an aspect of the present invention, the first stem includes a passageway which is formed through the first stem and covered by the sealing cap.

According to another aspect of the present invention, the first stem comprises a base having a circular plate-shaped member with a predetermined thickness and a passageway formed through a center of the base, a plurality of stem pins which are connected to a corresponding electron gun on an inner side of the base and pass through a circumferential portion of the base to extend outwardly on an outer side of the base by a predetermined distance, and an exhaust pipe having one end connected to the base to communicate with the passageway and a distal end fashioned with a sealing cap such that the distal end of the exhaust pipe extends in a direction away from the necks by a predetermined distance.

According to yet another aspect of the present invention, the first stem is an exhaust stem such that only the first stem allows the air inside the CRT to exhaust prior to having the sealing cap.

According to still another aspect of the present invention, each of the second stems comprises a base having a circular plate-shaped member with a predetermined thickness, and a plurality of stem pins which are connected to a corresponding electron gun on an inner side of the base and pass through a circumferential portion of the base to extend outwardly on an outer side of the base by a predetermined distance.

According to still yet another aspect of the present invention, each of the second stems further comprises a support member mounted to one side of the base which allows easy assembly of the second stems with the electron guns.

According to an additional aspect of the present invention, the support member has a cylindrical shape with a hollow center.

### BRIEF DESCRIPTION OF THE DRAWINGS

These and other objects and advantages of the invention will become apparent and more appreciated from the following description of the preferred embodiments, taken in conjunction with the accompanying drawings of which:

FIG. 1 is a perspective view of a cathode ray tube according to an embodiment of the present invention;

FIG. 2 is a sectional view taken along line I-I of FIG. 1;

FIG. 3 is a sectional view of a first stem mounted on a neck according to the embodiment shown in FIGS. 1 and 2;

FIG. 4 is a sectional view of a second stem mounted on a neck according to the embodiment shown in FIGS. 1 and 2;

FIG. 5 is a sectional view of a first stem prior to mounting on a neck according to the embodiment shown in FIGS. 1 and 2;

FIG. 6 is a sectional view of a second stem prior to mounting on a neck according to the embodiment shown in FIGS. 1 and 2;

FIG. 7 is a sectional view of a second stem prior to mounting on a neck according to another embodiment of the present invention;

FIG. 8 is a schematic view illustrating a mounting process of a stem to an electron gun according to an aspect of the present invention;

FIG. 9 is a schematic view illustrating a joining process of a stem to a neck according to another aspect of the present invention;

FIG. 10 is a schematic view illustrating an evacuation process of a CRT bulb of the present invention according to yet another aspect of the present invention; and

FIG. 11 is a schematic view illustrating an evacuation process of a conventional multi-neck CRT bulb.

### DETAILED DESCRIPTION OF THE PREFERRED EMBODIMENT

Reference will now be made in detail to the present preferred embodiments of the present invention, examples of which are illustrated in the accompanying drawings, wherein like reference numerals refer to like elements throughout.

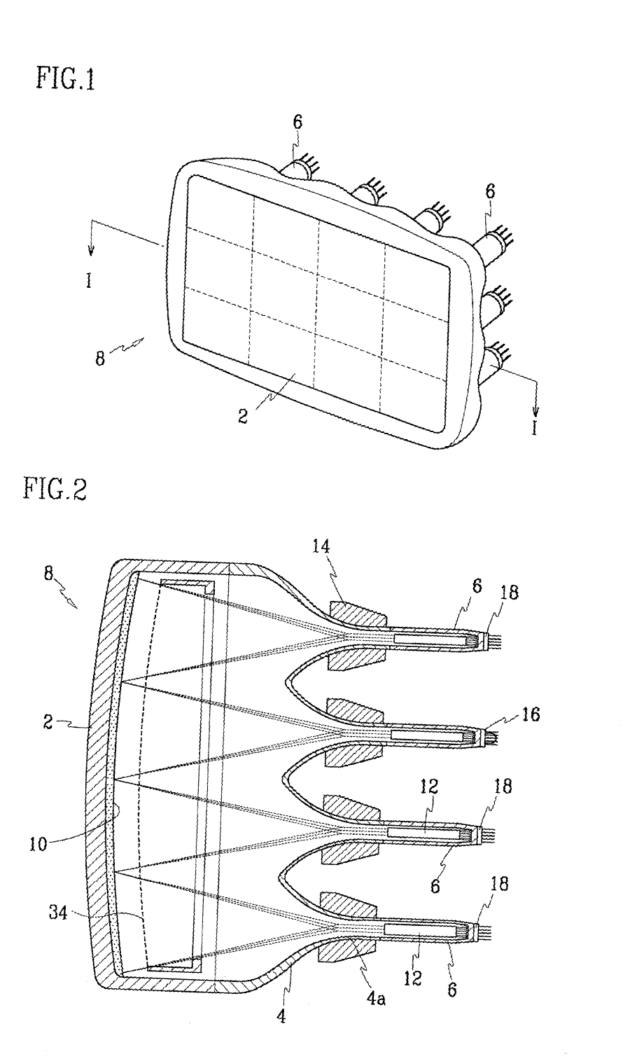

FIG. 1 shows a perspective view of a cathode ray tube (CRT) according to an embodiment of the present invention. FIG. 2 shows a sectional view taken along line I-I of FIG. 1.

A bulb 8 defines an exterior of the CRT and includes a face panel 2, a funnel 4, and a plurality of necks 6 that are integrally fused to each other. A phosphor screen 10 having a plurality of R,G,B phosphors is formed on an inner surface of the face panel 2. A color selecting assembly 34 having a shadow mask (not shown) is mounted within the bulb 8 at a predetermined distance from the phosphor screen 10. The funnel 4 includes cones 4a corresponding to each of the necks 6.

An electron gun 12 is positioned in each of the necks 6 and emits electron beams toward the phosphor screen 10. A deflection yoke 14 is mounted externally to each of the cones 4a such that there is a deflection yoke 14 for each of the electron guns 12. The deflection yokes 14 deflect the electron beams emitted from the electron guns 12. The electron beams emitted from the electron guns 12 scan a specific region of the phosphor screen 10 by an operation of the deflection yokes 14. For example, if the CRT has an arrangement of twelve electron guns 12 and a corresponding number of deflection yokes 14 (i.e., three rows of four), the phosphor screen 10 is divided into the same number of regions, that is, twelve. Each of the deflection yokes 14 deflects the electron beams emitted from the electron gun 12 that it is paired with, so that the electron beams move across rasters in a designated region of the phosphor screen 10. Accordingly, images are realized by the combination of separately drawn regions.

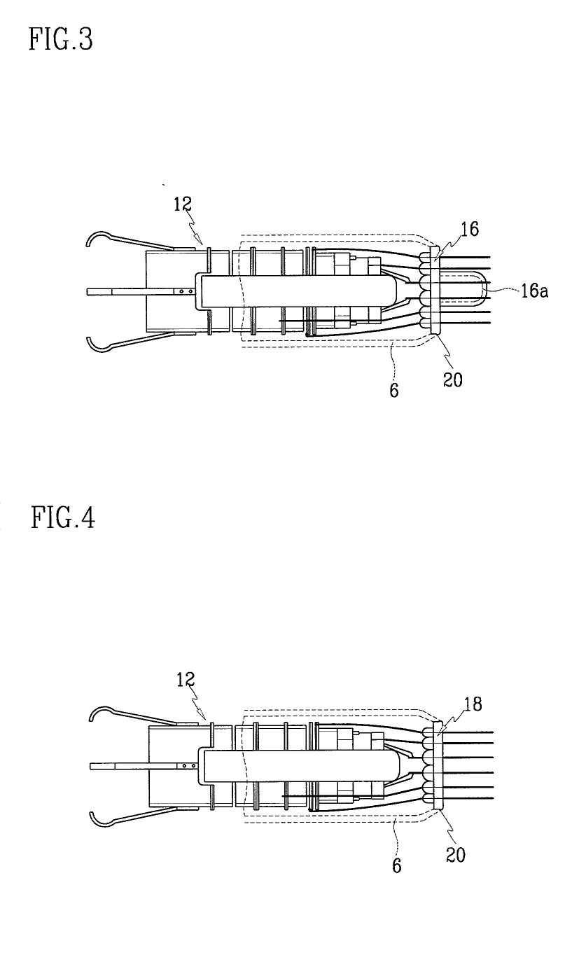

FIGS. 3 and 4 show electron guns 12 that are fixed to a first stem 16 or a second stem 18. The first and second stems 16 and 18 are fused to a distal end of the necks 6, and allow an easy evacuation and sealing of the bulb 8 (FIG. 2). Specifically, the first and second stems 16 and 18 are adhered to a corresponding distal end of the necks 6 and then fused in this position to form fusing portions 20. Accordingly, the first stem 16 is fused to one of the necks 6 and a plurality of the second stems 18 are fused to the remaining necks 6. The first stem 16, with reference to FIG. 3, includes a sealing cap 16a which protrudes outwardly from the first stem 16, while each of the second stems 18, with reference to FIG. 4, do not include the sealing cap. The purpose of this difference in configuration will be described below.

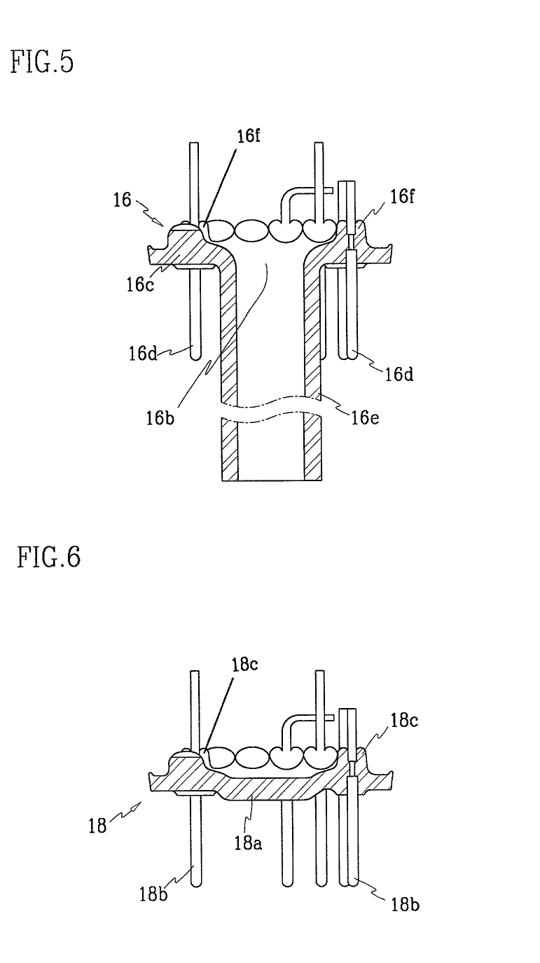

FIGS. 5 and 6 show first and second stems 16 and 18 prior to mounting on the necks 6 (FIG. 2). Referring to FIG. 5, the first stem 16 includes a base 16c having a passageway 16b formed through a center thereof, a plurality of stem pins 16d which are connected to an electron gun 12 (FIG. 3) on an inner side of the base 16c and pass through the base 16c to extend outwardly on an outer side of the base 16c by a predetermined distance, and an exhaust pipe 16e which communicates with the passageway 16b and extends in a direction away from the necks 6 (FIG. 2) by a determined distance, as connected to one of the necks 6 (FIG. 3).

The base 16c of the first stem 16 is a circular plate-shaped member having a predetermined thickness and is formed with an outer circumference that corresponds to a shape of the distal end of the neck 6 (FIG. 3), where the first stem 16 is fused to the distal end to form a fusing portion 20 (FIG. 3). The stem pins 16d are mounted to mounds 16f of the base 16c of the first stem 16. The mounds 16f protrude slightly toward the inner side of the base 16c.

The first stem 16 according to the embodiment above, has the same structure as stems of a conventional CRT. In addition, as with the conventional CRT, a distal end of the exhaust pipe 16e is sealed following the evacuation of the CRT to close off the passageway 16b. The resulting configuration of the sealed exhaust pipe 16e is shown in FIG. 3. As shown in FIG. 3, a sealing cap 16a of the first stem 16 is formed so as to close off of the exhaust pipe 16e. Before the exhaust pipe 16e is sealed, it allows communication between an inside of the bulb 8 (FIG. 2) and an exhaust unit such that the first stem 16 acts as an exhaust stem.

Referring to FIG. 6, each of the second stems 18 includes a base 18a having a circular plate-shaped member of a predetermined thickness, and a plurality of stem pins 18b which are connected to an electron gun 12 (FIG. 4) on an inner side of the base 18a and pass through the base 18a to extend outwardly on an outer side of the base 18a by a predetermined distance. The stem pins 18b are mounted to mounds 18c of the base 18a, and the mounds 18c protrude slightly toward the inner side of the base 18a.

The second stems 18 are attached to the necks 6 (FIG. 2) and sealed. With a configuration of the first stem 16 and the second stems 18 according to an embodiment of the present invention, a multi-neck CRT can be produced using a conventional CRT exhaust unit for a single neck without requiring additional processes or special devices. It is understood however, that the first stem 16 can be provided to more than one of the necks 6 (FIG. 2).

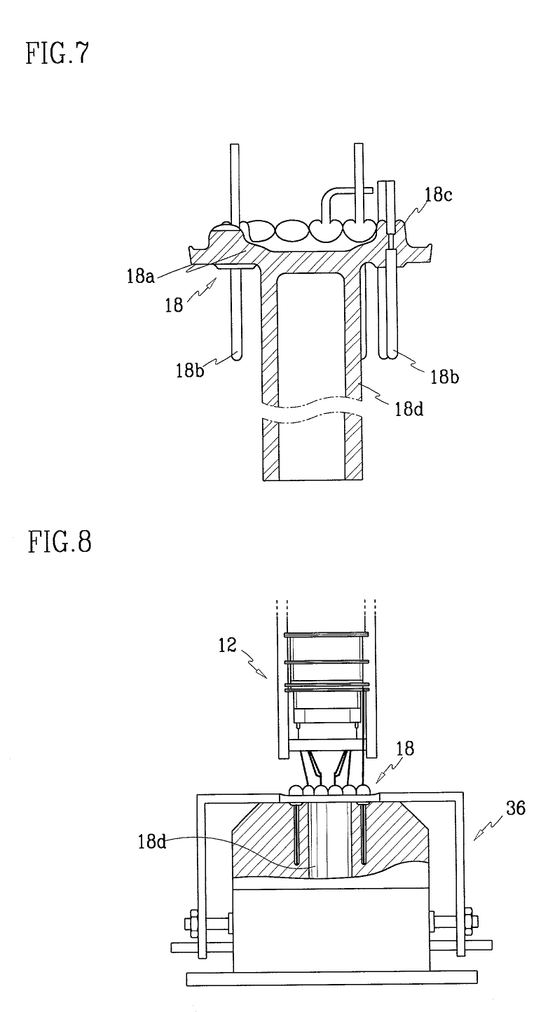

FIG. 7 shows a sectional view of one of the second stems 18 (FIG. 2) prior to mounting on one of the necks 6 (FIG. 2) according to another embodiment of the present invention. The second stem 18 of FIG. 7 is structurally identical to an embodiment of FIG. 6, except that a support member 18d has been added to the structure. The support member 18d allows the precise alignment and easy assembly of the second stems 18 to the necks 6 (FIG. 2).

The support member 18d is cylindrical with a hollow center, and is preferably formed identically to the exhaust pipes 16e of the first stems 16 (FIG. 5). However, a passageway is not formed to the base 18a of the second stems 18. Therefore, the support member 18d is not in communication with the inside of the bulb 8 (FIG. 2). After the second stems 18 are assembled to the necks 6 (FIG. 2), a predetermined portion or all of the support members 18d is removed to reduce the length of the support members 18d.

A method of manufacturing a CRT of the present invention and a method of evacuating the air inside the CRT of the present invention will be described below.

A sealing fixture corresponding to the structure of a CRT of the present invention is prepared. Referring to FIG. 2, the face panel 2, the plurality of necks 6 and the funnel 4 are mounted on the sealing fixture. A frit glass (not shown) is positioned at boundaries between the necks 6 and the funnel 4, and between the funnel 4 and the face panel 2. The sealing fixture containing the elements of the CRT positioned thereon is then placed in a sealing oven. Heating the sealing fixture at a high temperature melts the frit glass to form the bulb 8 with the face panel 2, the funnel 4, and the necks 6 fused into a single integrally formed unit.

As shown in FIGS. 3 and 4, the first stem 16 is formed with the sealing cap 16a, while each of the second stems 18 are formed without the sealing cap.

Referring to FIG. 5, preparing the first stem 16 includes forming the base 16c having the passageway 16b formed through the center thereof, and fusing (using heat) one end of the exhaust pipe 16e to the outer surface of the base 16c (i.e., the outer surface when assembled to one of the necks 6 (FIG. 2)) such that the exhaust pipe 16e encompasses the passageway 16b.

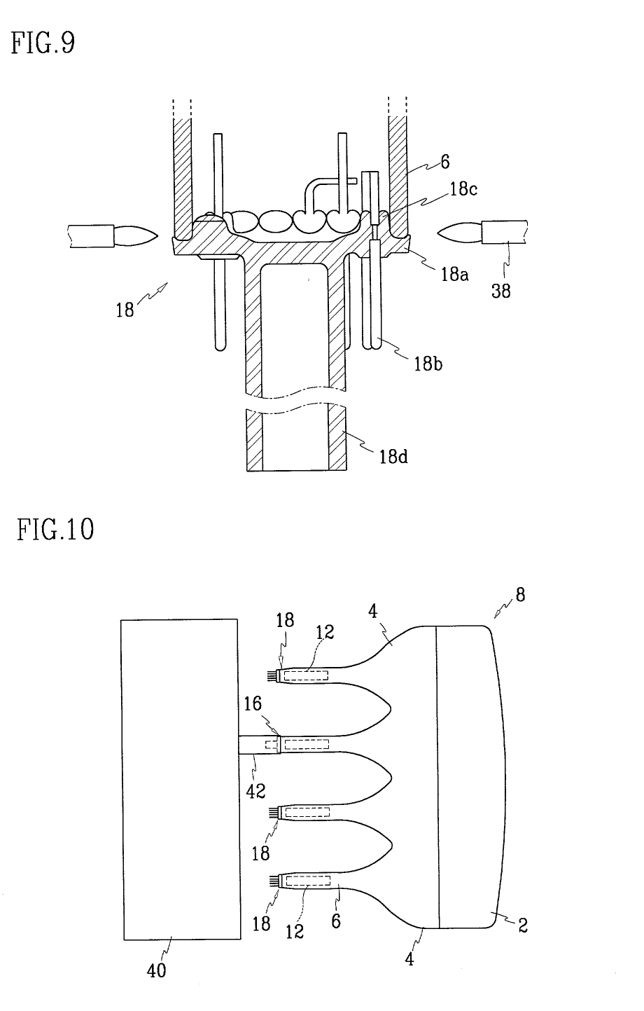

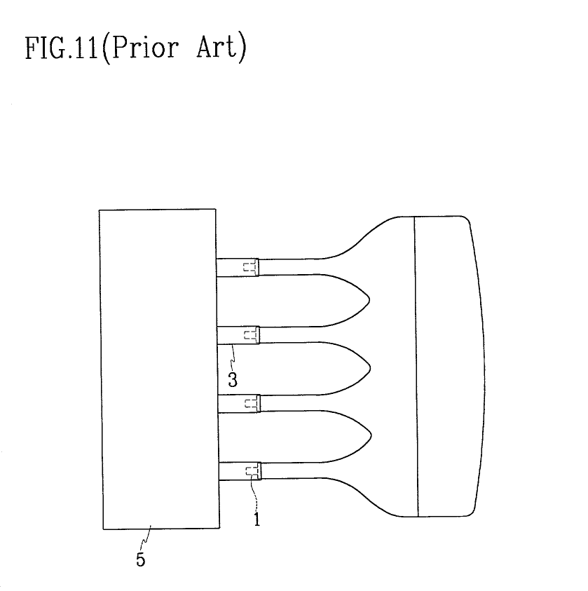

Referring to FIG. 9, preparing each of the second stems 18 includes forming the base 18a, and fusing the support member 18d to the outer surface of the base 18a (i.e., the outer surface when assembled to one of the necks 6). By using the same structure for the support members 18d of the second stems 18 and for the exhaust pipe 16e of the first stem 16, the manufacturing process for the CRT of the present invention can be simplified. Accordingly, the only difference between the first and second stems 16 and 18 is that the base 16c of the first stem 16 has the passageway 16b.

Next, the first and second stems 16 and 18 are positioned on a stem mounting unit, and assembled electron guns 12 are fixed to the first and second stems 16 and 18. For example, FIG. 8 shows one of the second stems 18 having a support member 18d positioned on a steam mounting unit 36. The one of the second stems 18 is connected to an electron gun 12 by welding an internally-extending portion of the stem pins 18b (FIG. 7) to electrodes and heater support assemblies of the electron gun 12. Using the same process, the first stem 16 and the remaining second stems 18 are connected to the electron guns 12.

The first and second stems 16 and 18 with the electron guns 12 attached thereto are then connected to the necks 6. For example, FIG. 9 shows one of the second stems 18 having a support member 18d extending in a direction away from the CRT, such that an outer circumference of a base 18a is placed flush against one end of the neck 6. Using a heating unit 38, such as a welding torch, the contacting portions of the second stem 18 and the neck 6 are fused. Similarly, the first stem 16 is connected to one of the necks 6 and the remaining second stems 18 are connected to the remaining necks 6.

FIG. 10 shows that a resulting bulb 8 is mounted to an exhaust unit 40. That is, the exhaust pipe 16e (FIG. 5) of the first stem 16 is fixed to a suction tube 42 of the exhaust unit 40. Accordingly, the exhaust unit 40 communicates with the inside of the bulb 8 and operates to evacuate the air in the bulb 8 to a vacuum state of approximately 10⁻⁷ torr. Since only one of the stems (the first stem 16) is used to evacuate the bulb 8 of the present invention, an exhaust unit having a single suction tube used for conventional single-neck CRTs may be used for the present invention. Accordingly, a special exhaust unit or additional processes following the mounting of the electron guns 12 is not required.

After evacuation of the bulb 8 through the first stem 16, an oven heater (not shown) that is mounted in proximity of the exhaust pipe 16e (FIG. 5) of the first stem 16 is used to fuse the distal end of the exhaust pipe 16e. Accordingly, the distal end of the exhaust pipe 16e (FIG. 5) with an open structure closes to form a sealing cap 16a shown in FIG. 3.

In addition to being compatible with a conventional exhaust unit, the multi-neck CRT of the present invention has a lower loss of vacuum than conventional multi-neck CRTs with multiple suction tubes. With multiple suction tubes, multiple evacuation and sealing processes are required, resulting in a higher loss of vacuum due to the gases generated during the multiple sealing processes.

With the second stems 18 having the support members 18d (FIG. 9), part or all of the support members 18d (FIG.9) must be removed following the evacuation of the bulb 8 and sealing of the exhaust pipe 16e of the first stem 16. To do so, an imperfection is made to the support members 18d (FIG. 9), prior to the evacuation process, such that cracks are formed in the support members 18d (FIG. 9) during a high temperature evacuation process. As a result, the support members 18d (FIG. 9) are easily removed. If the cracks formed in the support members 18d (FIG. 9) are insufficient to allow easy removal of the support members 18d (FIG. 9), the oven heater used during the sealing of the exhaust pipe 16e (FIG. 5) of the first stem 16 may be used to heat the support members 18d (FIG. 9), to less than a fusing point, to enable easy removal of the support members 18d (FIG. 9).

As final steps in the manufacture of the CRT, a conventional getter flashing process is performed to remove excess gases in the bulb 8, and the deflection yokes 14 (FIG. 2) are mounted to the outside of the cones 4a (FIG. 2).

The multi-neck CRT of the present invention has only one of the stems with the means to evacuate the bulb while the remaining stems are closed. Therefore, a direct application of a conventional exhaust unit for a single-neck CRT structure is possible. Accordingly, a special exhaust unit with a plurality of suction tubes is unnecessary. Also, since multiple sealing processes are not needed, gases generated during a sealing process are minimized, resulting in a multi-neck CRT with a minimal loss of vacuum.

The present invention is not limited to a CRT having a plurality of necks and electron guns, and a color selecting assembly including a shadow mask mounted to the inside of a panel of the CRT. It is possible to apply the present invention to other types of CRTs, such as a BIT (beam index tube) CRT having a plurality of necks and electron guns, a phosphor screen formed on an inner surface of a panel, an index phosphor material formed on the phosphor screen, and a detector which detects light emitted from the index phosphor material mounted to an outer circumference of a funnel. In addition, the first stem of the present invention can be provided to more than one of the necks so as to have more than one evacuation stem. Since the first stem is not provided to all of the necks in the present invention, additional sealing process to seal the remaining necks is not required after the evacuation and sealing of the first stems.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A cathode ray tube comprising:
a face panel including a phosphor screen formed on an inner surface of the face panel;
a funnel including one end fused to the face panel and another end having a plurality of cones;
a plurality of necks, wherein each neck is connected to a corresponding one of the cones;
a plurality of electron guns which emit electron beams toward the phosphor screen, wherein each electron gun is provided in a corresponding one of the necks;
a plurality of deflection yokes which deflect corresponding ones of the electron beams emitted from the electron guns, wherein each deflection yoke is mounted to an outer circumference of a corresponding one of the cones; and
a plurality of stems including a first stem having a sealing cap which extends outward from a corresponding one of the necks and second stems formed such that each of the second stems is without the sealing cap, wherein each stem is fused to a distal end of a corresponding one of the necks and connected to a corresponding one of the electron guns.

2. The cathode ray tube of claim 1, wherein the first stem further comprises a passageway formed through the first stem and covered by the sealing cap.

3. The cathode ray tube of claim 2, wherein the first stem further comprises:
a base including a circular plate-shaped member having a predetermined thickness and the passageway formed through a center of the base;
a plurality of stem pins connected to the corresponding electron gun on an inner side of the base and pass through a circumferential portion of the base to extend outwardly on an outer side of the base by a predetermined distance; and
an exhaust pipe of a predetermined length having one end connected to the outer side of the base to communicate with the passageway and another end of the exhaust pipe covered by the sealing cap.

4. The cathode ray tube of claim 1, wherein the first stem is an exhaust stem such that only the first stem allows air inside the cathode ray tube to exhaust prior to sealing of the first stem.

5. The cathode ray tube of claim 1, wherein each of the second stems comprises:
a base including a circular plate-shaped member having a predetermined thickness; and
a plurality of stem pins connected to the corresponding electron gun on an inner side of the base and pass through a circumferential portion of the base to extend outwardly on an outer side of the base by a predetermined distance.

6. The cathode ray tube of claim 5, wherein each of the second stems further comprises a support member mounted to the outer side of the base which allows alignment and assembly of each of the second stems with the corresponding one of the electron guns.

7. The cathode ray tube of claim 6, wherein the support member is cylindrical with a hollow center.

8. The cathode ray tube of claim 3, wherein each of the second stems comprises:
a stem base including another circular plate-shaped member having a second predetermined thickness; and
a plurality of second stem pins connected to the corresponding electron gun on an interior side of the stem base and pass through another circumferential portion of the stem base to extend outwardly on an exterior side of the stem base by a second predetermined distance.

9. The cathode ray tube of claim 8, wherein each of the second stems further comprises a support member mounted to the exterior side of the stem base which allows alignment and assembly of each of the second stems with the corresponding one of the electron guns.

10. The cathode ray tube of claim 9, wherein the support member is cylindrical with a hollow center.

11. The cathode ray tube of claim 10, wherein the first stem is an exhaust stem such that only the first stem allows air inside the cathode ray tube to exhaust prior to sealing of the first stem.

12. A cathode ray tube comprising:
a face panel including a phosphor screen formed on an inner surface of the face panel;
a funnel including one end fused to the face panel and another end having a plurality of cones;
a plurality of necks, wherein each neck is connected to a corresponding one of the cones;
a plurality of electrons guns which emit electron beams toward the phosphor screen, wherein each electron gun is provided to a corresponding one of the necks;
a plurality of deflection yokes which deflect corresponding ones of the electron beams emitted from the electron guns, wherein each deflection yoke is mounted to an outer circumference of a corresponding one of the cones; and
a plurality of stems including a first stem which allows air inside the cathode ray tube to exhaust prior to having a sealing cap, and second stems which do not allow the air inside the cathode ray tube to exhaust, wherein each stem is connected to a distal end of a corresponding one of the necks and to a corresponding one of the electron guns.

13. The cathode ray tube of claim 12, wherein the first stem further comprises:
a base having a predetermined thickness and a passageway formed through a center of the base;
a plurality of stem pins connected to the corresponding electron gun on an inner side of the base and pass through the base to extend to an outer side of the base by a predetermined distance; and
an exhaust pipe of a predetermined length having one end connected to the outer side of the base to communicate with the passageway and another end covered by the sealing cap.

14. The cathode ray tube of claim 13, wherein each of the second stem comprises:
a stem base having another predetermined thickness; and
a plurality of second stem pins connected the corresponding electron gun on an interior side of the stem base and pass through the stem base to extend to an exterior side of the stem base by another predetermined distance.

15. The cathode ray tube of claim 14, wherein each of the second stems further comprises a support member mounted to the exterior side of the stem base which allows alignment and assembly of each of the second stems with the corresponding one of the electron guns.

16. The cathode ray tube of claim 15, wherein the support member is cylindrical with a hollow center.

17. The cathode ray tube of 12, wherein the first stem is an exhaust stem such that only the first stem allows the air inside the cathode ray tube to exhaust prior to sealing of the first stem.

18. A cathode ray tube comprising:
a face panel including a phosphor screen formed on an inner surface of the face panel;
a funnel including one end fused to the face panel and another end having a plurality of cones;
a plurality of necks, wherein each neck is connected to a corresponding one of the cones;
a plurality of electron guns which emit electron beams toward the phosphor screen, wherein each electron gun is provided in a corresponding one of the necks;
a plurality of deflection yokes which deflect corresponding ones of the electron beams emitted from the electron guns, wherein each deflection yoke is mounted to an outer circumference of a corresponding one of the cones; and
a plurality of stems including at least one first stem having a sealing cap which extends outward from a corresponding one of the necks and at least one second stem formed such that the second stem is without the sealing cap, wherein each stem is fused to a distal end of a corresponding one of the necks and connected to a corresponding one of the electron guns.

19. The cathode ray tube of 18, wherein the first stem is provided in only one of the necks.
